(19) United States
(12) Patent Application Publication
(10) Pub. No.: US 2026/0074611 A1
(43) Pub. Date: Mar. 12, 2026

(54) POWER CONVERSION SYSTEM WITH SOLAR POWERED ENVIRONMENTAL CONTROL

(71) Applicant: EPC Power Corporation, Poway, CA (US)

(72) Inventors: William Giewont, Poway, CA (US); Devin Dilley, Poway, CA (US); Jonathan Parker, Poway, CA (US); Michael Schreiber, Poway, CA (US)

(73) Assignee: EPC Power Corporation, Poway, CA (US)

(21) Appl. No.: 19/007,099

(22) Filed: Dec. 31, 2024

Related U.S. Application Data
(60) Provisional application No. 63/691,876, filed on Sep. 6, 2024.

(51) Int. Cl. H02M 1/32; H02J 7/00; H02J 7/35; H02S 10/20

(52) U.S. Cl. CPC H02M 1/327; H02J 7/35; H02J 7/855; H02S 10/20; H02J 2101/24

(57) ABSTRACT

A power conversion system can include a housing, a frame to support the housing, a solar assembly having a plurality of solar cells, an inverter, and a temperature management system. The inverter can electrically couple with the solar assembly, receive direct current (DC) power from the plurality of solar cells, convert the DC power into alternating current (AC) power, and provide the AC power to a temperature management system of the power conversion system. The temperature management system can monitor an environment of an internal cavity of the housing and provide temperature-controlled air throughout the internal cavity of the housing to control the environment of the internal cavity of the housing.

### CROSS-REFERENCE TO RELATED PATENT APPLICATIONS

This application claims the benefit of and priority to U.S. Provisional Patent Application No.: 63/691,876, filed Sep. 6, 2024, the entirety of which is incorporated by reference herein.

### BACKGROUND

Renewable energy sites include solar panels to produce electrical power from sunlight.

### SUMMARY

At least one embodiment relates to a power conversion system including a housing. The housing can include a plurality of sides to define a shape of the housing. The power conversion system can include a frame disposable on a ground surface. The frame can support the housing. The power conversion system can include a solar assembly. The solar assembly can be coupled with a first side of the plurality of sides. The solar assembly can include a plurality of solar cells. The power conversion system can include an inverter. The inverter can be electrically coupled with the solar assembly. The inverter can receive direct current (DC) power from the plurality of solar cells. The inverter can convert the DC power into alternating current (AC) power. The inverter can provide the AC power to a temperature management system of the power conversion system. The power conversion system can include the temperature management system. The temperature management system can monitor an environment of an internal cavity of the housing. The temperature management system can provide temperature-controlled air throughout the internal cavity of the housing to control the environment of the internal cavity of the housing.

At least one embodiment relates to a power conversion system. The power conversion system can include a housing. The housing can include a cavity to dispose an inverter. The power conversion system can include a solar assembly. The solar assembly can be coupled with an external side of the housing. The solar assembly can include a plurality of solar cells. The power conversion system can include an environment management system. The environment management system can be electrically coupled with the plurality of solar cells. The environment management system can receive direct current (DC) power from the plurality of solar cells. The environment management system can control an environment throughout the cavity.

At least one embodiment relates to a power conversion system. The power conversion system can include a housing. The housing can define an internal cavity. The power conversion system can include a solar assembly. The solar assembly can couple to an external side of the housing. The solar assembly can include a plurality of solar cells. The plurality of solar cells can generate direct current (DC) power. The power conversion system can include an inverter. The inverter can receive DC power from the plurality of solar cells. The inverter can convert the DC power into alternating current (AC) power. The inverter can provide the AC power to an environment management system within the housing. The environment management system can monitor environmental conditions within the internal cavity. The environment management system can regulate temperature by circulating temperature-controlled air within the internal cavity using the AC power.

### BRIEF DESCRIPTION OF THE DRAWINGS

FIG. 1 is a perspective view of a power conversion system, according to some embodiments.

FIG. 2 is a perspective view of the power conversion system of FIG. 1, according to some embodiments.

FIG. 3 is a block diagram of a system to regulate an environment of one or more components of the power conversion system of FIG. 1, according to some embodiments.

FIG. 4 depicts an aerial view of a renewable energy site, according to some embodiments.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Systems and methods to provide power to an environment management system of a power conversion system are described herein. Power conversion systems (e.g., inverters, converters, rectifiers, etc.) are vital components for renewable energy sites (solar farms, wind farms, etc.) as the power conversion systems provide for conversion and/or storage of energy produced at the renewable energy sites. For example, inverters may be coupled with multiple solar panel arrays to convert direct current (DC) power, produced by the solar panel arrays, into alternating current (AC) power for distribution to power various devices.

Renewable energy sites are often located at reconfigured, modified, and/or altered locations. For example, a solar farm may be constructed in an open field that is without any infrastructure (e.g., water, gas, electric, etc.). The design and implementation of renewable energy sites consumes a significant amount of time (e.g., 6 months, 1 year, 2 years, etc.) prior to operation (e.g., generation of power) of the renewable energy sites. During the design and implementation of the renewable energy sites, components (e.g., hardware, circuitry, devices, etc.) may be disposed at and/or otherwise left at the renewable energy sites. For example, power inverters that will be used to convert power, provided by solar cells, are often delivered to the renewable energy site during the early stages of construction. However, given that the renewable energy sites are idle (e.g., no power production) for months on end, components delivered during the early stages of construction do not have access to power.

The lack of accessible power to components during the construction of renewable energy sites provides several complications for the components. For example, a power conversion and storage unit may include environment control devices. However, the environment control devices rely on energy from the renewable energy sites (e.g., solar panels, wind turbines, etc.) to power the various elements of the environment control devices. Accordingly, the environment control devices are unable to regulate the environment of the power conversion and storage unit when the renewable energy site is undergoing construction. This inability to control the environment of the power conversion and storage unit can result in damage to the power conversion and storage unit as components may overheat even though the power conversion and storage unit is not operating. For example, relay devices (e.g., switches, metal-oxide-semiconductor field-effect transistors (MOSFETs), insulated-gate bipolar transistors (IGBT), etc.) are sensitive to moisture (e.g., humidity, water particles, water droplets, etc.). The relay devices may experience problems (e.g., faults, decreased sensitivity, increased sensitivity, etc.) responsive to exposure to moisture.

Some technical solutions described herein include a power conversion system and/or power conversion and storage unit having an independent power supply to provide power to an environment management system. The independent power supply does not rely on power from a renewable energy site and as such the independent power supply can provide power to the power conversion system even during the construction phase of the renewable energy site. For example, the independent power supply may include solar panels that provide power to an inverter of the power conversion system. The inverter can then provide power to the environment management system to allow for the environment management system to control an environment of the power conversion system. As another example, the environment management system may be directed coupled with the solar panels such that the solar panels directly provide power to the environment management system. Advantageously, the power conversion system is not reliant on the renewable energy site to provide power to the environment management system.

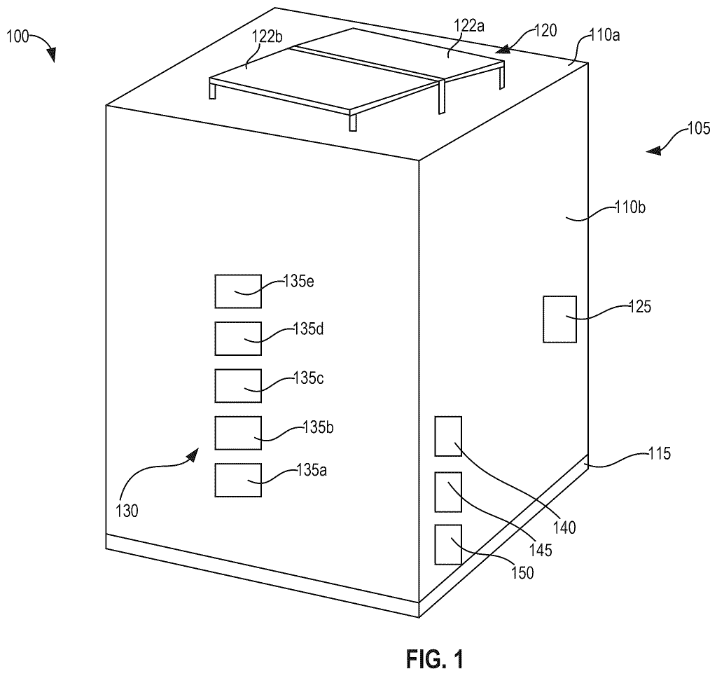

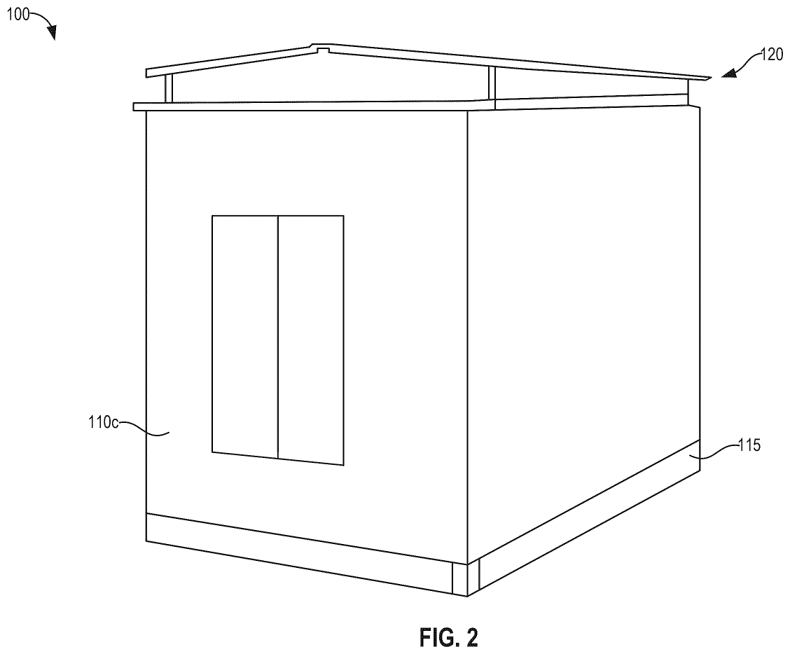

FIGS. 1-2 depict perspective views of a power conversion system 100, according to some embodiments. In some embodiments, the power conversion system 100 may provide power conversion at a renewable energy site. For example, the power conversion system 100 may electrically couple (directly and/or indirectly) with one or more solar panels at a solar farm. In some embodiments, the power conversion system 100 may provide some of the technical solutions described herein.

As shown in FIG. 1, the power conversion system 100 includes a housing 105 (e.g., a structure, a body, an enclosure, etc.) to house and/or provide an area for one or more components of the power conversion system 100. In some embodiments, the housing 105 may include one or more sides and/or surfaces, shown as sides 110 in FIG. 1. For example, the housing 105 may include a first side 110a to define a top portion and/or top surface of the power conversion system 100. As another example, the housing 105 may include a second side 110b to define a side portion and/or a side surface of the power conversion system 100. In some embodiments, the sides 110 may define a shape of the housing 105. For example, the sides may define an overall dimension and/or arrangement of the housing 105. In some embodiments, the sides 110 may define and/or establish a cavity and/or compartment. For example, the sides 110 may isolate an internal portion (e.g., cavity) from an external environment.

As shown in FIGS. 1 and 2, the power conversion system 100 includes a frame and/or support surface, shown as frame 115, to provide a support system for the power conversion system 100. For example, the frame 115 may be disposable on a ground surface (e.g., grass, dirt, roadway, a street, a floor, a field, a yard, etc.) to provide a surface and/or structure for which the housing 105 and/or one or more additional components of the power conversion system 100 may rest on. Stated otherwise, the frame 115 may provide a foundation to support one or more components of the power conversion system 100. In some embodiments, the frame 115 may support the housing 105. For example, the housing 105 may be coupled with the frame 115 via one or more fasteners to secure and/or attach the housing 105 with the frame 115. As another example, the housing 105 may be inserted and/or otherwise positioned within at least a portion of the frame 115.

As shown in FIGS. 1 and 2, the power conversion system 100 includes at least one solar assembly 120. For example, the solar assembly 120 can be positioned and/or placed on the side 110a (e.g., on top of the housing 105). As another example, the solar assembly 120 may be attached and/or secured to the housing 105. In some embodiments, the solar assembly 120 may include one or more solar panels and/or electrical devices, shown as solar cells 122, to facilitate the capture, receipt, and/or conversion of solar energy. For example, the solar cells 122 may include one or more photovoltaic (PV) cells that may convert sunlight into electrical power (e.g., energy, electricity, etc.).

While FIG. 1 shows the solar assembly 120 as including a first solar cell 122a and a second solar cell 122b, this is for illustrative purposes only and is in no way limiting. For example, the solar assembly 120 may include more than two solar cells. As another example, the solar assembly 120 may include less than two solar cells. In some embodiments, the solar assembly 120 may be provided as a discrete and/or separate component to that of the power conversion system 100. For example, the solar assembly 120 may be added to and/or provided to the power conversion system 100 after and/or subsequent to the construction and/or assembly of the power conversion system 100. As another example, the solar assembly 120 may be positioned and/or placed adjacent to and/or proximate to the power conversion system 100 (e.g., the solar assembly 120 may be placed on a ground surface, coupled with a ground mounting mechanism, placed on a separate surface, etc.).

In some embodiments, the solar assembly 120 may be electrically coupled with one or more components and/or electrical circuitry of the power conversion system 100. For example, the solar assembly 120 (and/or the solar cells 122) may be electrically coupled with at least one coolant systems, energy storage devices, power converter devices, and/or other electrical circuitry of the power conversion system 100. In some embodiments, the solar assembly 120 may provide and/or otherwise forward electrical energy, converted from sunlight and/or solar energy, to provide electrical energy to power one or more components and/or devices of the power conversion system 100.

As shown in FIG. 1, the power conversion system 100 includes an opening and/or void, shown as connector assembly 125, to facilitate the coupling and/or attaching of multiple power conversion systems 100. For example, the connector assembly 125 provides an opening to facilitate electrical coupling of electrical circuitry of a first power conversion system 100 with electrical circuitry of a second power conversion system 100 and/or with main power. As another example, the connector assembly 125 may provide access to the cavity and/or internal portion of the power conversion system 100.

As shown in FIGS. 1 and 2, the power conversion system 100 includes at least one ventilation assembly 130 to facilitate circulation and/or movement of air throughout the power conversion system 100. For example, the ventilation assembly 130 is shown to include ventilation devices 135 (e.g., fans, air flow devices, etc.) to circulate and/or otherwise move air throughout the housing 105. In some embodiments, the ventilation assembly 130 and/or the ventilation devices 135 may include passive elements. For example, the ventilation assembly 130 may include one or more openings and/or spaces such that air may enter and/or leave the housing 105.

As shown in FIG. 1, the power conversion system 100 includes a coolant system and/or an environment control system, shown as environment management system 140, to facilitate control and/or adjustment of the temperature and/or environment of the power conversion system 100 and/or one or more components thereof. For example, the environment management system 140 may control an internal environment (e.g., temperature, humidity, filtration, etc.) of the housing 105 by heating and/or cooling the internal cavity of the housing 105. As another example, the environment management system 140 may be coupled (e.g., electrically, communicably, etc.) with the ventilation assembly 130 to facilitate the circulation of air within the housing 105.

In some embodiments, the environment management system 140 may receive electrical energy from the solar assembly 120, either directly and/or indirectly. Stated otherwise, the environment management system 140 may operate from direct current (DC) power and as such may receive electrical power directly from the solar assembly 120. Additionally and/or alternatively, the environment management system 140 may operate from alternating current (AC) power and as such the DC power, from the solar assembly 120, may be provided to an inverter and/or power converter and the environment management system 140 may receive AC power from power converter.

As shown in FIG. 1, the power conversion system 100 includes power converter system, shown as inverter 145, to facilitate the transfer and/or conversion of electrical power. For example, the inverter 145 may receive DC power, from the solar assembly 120, and convert the DC to power AC power. As another example, the inverter 145 may include step-up and/or step-down electrical circuitry such that the DC power, from the solar assembly 120, may be increased and/or decreased to facilitate the transfer of DC to one or more components that operate on DC power.

In some embodiments, the inverter 145 may facilitate the transfer of electrical power by providing converted and/or adjusted electrical power (e.g., DC power converted to AC, DC to DC, AC to DC, etc.) to one or more components of the power conversion system 100. For example, the inverter 145 may be electrically coupled with the environment management system 140. To continue this example, the inverter 145 may provide AC power to the environment management system 140 to facilitate operation of the environment management system 140. In some embodiments, the inverter 145 may include at least one of power converters (e.g., AC to DC, DC to AC, DC to DC, AC to AC, etc.), filters, rectifiers, modifiers, and/or other possible electric signal modifying devices.

As shown in FIG. 1, the power conversion system 100 includes an energy storage system 150. For example, the energy storage system 150 may include batteries, energy storage, devices, etc. to store and/or keep electrical power provided by the solar assembly 120. In some embodiments, the energy storage system 150 may provide electrical power while the solar assembly 120 is idle and/or inactive (e.g., at night, during maintenance, etc.). Stated otherwise, the energy storage system 150 may provide electrical power to one or more components of the power conversion system 100 to supplement and/or support the solar assembly 120.

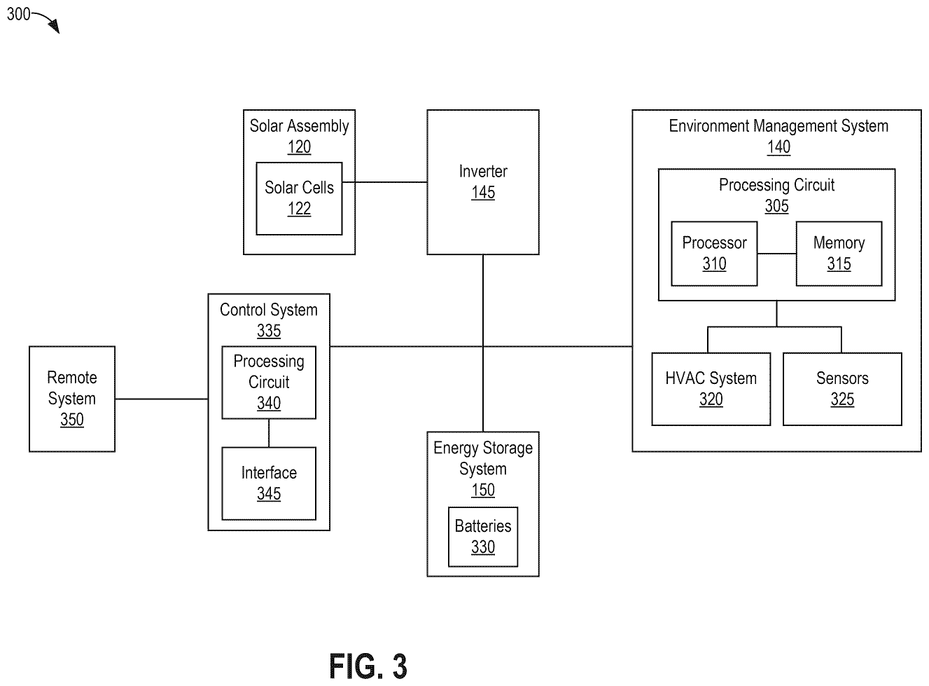

FIG. 3 is a block diagram of a system 300 to regulate an environment of one or more components of the power conversion system of FIG. 1, according to some embodiments. As shown in FIG. 3, the system 300 may include one or more components of the power conversion system 100. For example, the system 300 is shown to include the solar assembly 120, the environment management system 140, the inverter 145, and the energy storage system 150. In some embodiments, the lines and/or connections, as shown in FIG. 3, may refer to and/or illustrate connections and/or coupling between devices. For example, the line connecting the inverter 145 with the solar cells 122 may illustrate that the inverter 145 is electrically coupled with the solar cells 122. In some embodiments, the system 300 may be modified and/or adjusted such that one or more components may be moved, rearranged, replaced, separated, substituted, and/or otherwise changed. For example, the system 300 may be adjusted such that a first component that is shown directly coupled with a second component may be rearranged such that the first component is directly coupled with a third component.

In some embodiments, one or more components of the system 300 may be directly and/or indirectly coupled with one another. For example, the energy storage system 150 may be directly coupled with the solar assembly 120 such that the solar cells 122 directly provide DC power to the energy storage system 150. As another example, the energy storage system 150 may be indirectly coupled with the solar cells 122 such that the solar cells 122 provides DC power to an intermediate device and the intermediate device provides the DC power to the energy storage system 150.

In some embodiments, at least one of the components of the system 300 may operate with DC power. For example, the environment management system 140 may include environment control devices that operate with DC power. As another example, the environment management system 140 may include power converter devices and/or rectifiers that convert the DC power to AC power.

In some embodiments, the inverter 145 may be electrically coupled with the solar assembly 120. For example, the inverter 145 may be electrically coupled with the solar cells 122 via one or more wires and/or electrical coupling devices. The inverter 145 may receive DC power from the solar cells 122. For example, the inverter 145 may receive DC power as the solar cells 122 capture and/or otherwise convert sunlight into DC power. As another example, the inverter 145 may receive DC power from the solar cells continuously and/or semi-continuous.

In some embodiments, the inverter 145 may convert and/or otherwise adjust electrical power. For example, the inverter 145 may convert the DC power, received from the solar cells 122, into AC power. As another example, the inverter 145 may adjust the DC power, received from the solar cells 122, by increasing and/or decreasing a DC voltage provided by the DC power. In some embodiments, the inverter 145 may provide electrical power to one or more components of the power conversion system 100. For example, the inverter 145 may provide AC power to the environment management system 140 to power one or more components of the environment management system 140.

As shown in FIG. 3, the environment management system 140 includes a processing circuit 305, a heating, ventilation, and air conditioning (HVAC) system 320, and one or more sensors 325. In some embodiments, the one or more components of the environment management system 140 (e.g., the processing circuit 305, the HVAC system 320, the sensors 325, etc.) may receive electrical power from the inverter 145. The processing circuit 305 is shown to include a processor 310 and memory 315. The processor 310 may include various types of hardware, circuitry, and/or electrical devices. For example, the processor 310 may include a field programable gate array (FPGA), an application specific integrated circuit (ASIC), a general-purpose processor, a group of processing components, and/or or other processing components. Memory 315 may include one or more of volatile and/or non-volatile memory, database components, object code components, software, firmware, instructions, executable code, script components, and/or other types of information structure for support the various actions and/or processes described herein. For example, memory 315 may store executable code that, when executed by the processors 310, causes the processors 310 to perform one or more actions described herein.

In some embodiments, the sensors 325 may include at least one of temperature sensors (e.g., thermistors, integrated circuit sensors, resistance temperature detectors, etc.), humidity sensors (e.g., humistors, humidistats, etc.), and/or other electrical devices to detect and/or measure various types of information. In some embodiments, the environment management system 140 may monitor an environment of the power conversion system 100. For example, the sensors 325 may collect information that indicates an internal environment of the cavity of the housing 105. As another example, the sensors 325 may collect information that indicates an amount of airflow that is flowing through the housing 105.

In some embodiments, the HVAC system 320 may include one or more devices to facilitate and/or control an environment of the power conversion system 100. For example, the HVAC system 320 may include one or more of fans, cooling systems, heating elements, temperature control devices, vapor-compression devices, and/or air circulation devices. In some embodiments, the environment management system 140 may provide temperature-controlled air. For example, the environment management system 140 (e.g., the HVAC system 320) may provide cooled air into and/or through the housing 105 to control the temperature (e.g., environment) of the internal cavity of the housing 105. As another example, the environment management system 140 may control the environment of the housing 105 to regulate the temperature of one or more components located and/or housed within the housing 105 to prevent overheating of the components.

In some embodiments, the HVAC system 320 may include one or more dehumidification devices. For example, the HVAC system 320 may include at least one of dehumidifiers, dehumidification systems, absorbent materials (e.g., desiccant, hygroscopic substances, etc.), or other possible devices to control the humidity and/or the amount of water in the air. In some embodiments, the HVAC system 320 may control the humidity level of the internal cavity of the housing 105 to provide a dry environment to one or more components located and/or housed in the housing 105.

As shown in FIG. 3, the energy storage system 150 includes one or more batteries 330. In some embodiments, the batteries 330 may include one or more of lithium-ion batteries, lead-acid batteries, storage batteries, or other types of secondary cells that can store electrical energy. For example, the batteries 330 may store electrical energy, received from the solar cells 122, for subsequent use by the power conversion system 100 and/or one or more components thereof. As another example, the batteries 330 may discharge electrical energy to provide power to the environment management system 140. In some embodiments, the batteries 330 may receive electrical energy from the solar cells 122 and/or inverter 145. Stated otherwise, the batteries 330 may be charged via electrical energy provided by the solar cells 122 and/or the inverter 145.

In some embodiments, the energy storage system 150 and/or the batteries 330 may be directly coupled with the solar assembly 120. For example, the batteries 330 may receive DC power directly from the solar cells 122. Stated otherwise, the batteries 330 may receive DC power as the solar cells 122 produce the power. In some embodiments, the environment management system 140 may be directly coupled with the solar assembly 120 such that the environment management system 140 receives DC power directly from the solar cells 122. For example, the environment management system 140 may include one or more components that operate on DC power. To continue this example, the one or more components may receive DC power directly from the solar cells 122.

As shown in FIG. 3, the system 300 includes a control system 335 and a remote system 350. In some embodiments, the control system 335 may control one or more operations of the power conversion system 100. For example, the control system 335 may control operation of the inverter 145. As another example, the control system 335 may control whether the batteries 330 are receiving electrical energy (e.g., charging) and/or providing electrical energy (e.g., discharging).

In some embodiments, the remote system 350 may include one or more devices and/or systems remote to and/or separate from the power conversion system 100. For example, the remote system 350 may include at least one of a mobile device, a tablet, a computer, a desktop, a computing device, a monitor, a laptop, and/or an interactive display device. In some embodiments, the remote system 350 may receive one or more sets of information from the control system 335. For example, the control system 335 may include a battery management system. To continue this example, the remote system 350 may receive information regarding the charging and/or discharging of the batteries 330. As another example, the remote system 350 may receive location information regarding the power conversion system 100. Stated otherwise, the remote system 350 may receive location coordinates and/or other possible types of information to indicate a location of the power conversion system 100.

In some embodiments, the control system 335 includes at least one processing circuit 340 and at least one interface 345. The processing circuit 340 may control and/or perform one or more operations of the control system 335. For example, the processing circuit 340 may implement the battery management system of the control system 335. As another example, the processing circuit 340 may implement a tracking system.

In some embodiments, the processing circuit 340 may include at least one of the various types of circuitry, hardware, software, firmware, etc. as described herein. For example, the processing circuit 340 may include one or more processors coupled with memory. To continue this example, the one or more processors may execute instructions, stored in memory, to cause the one or more processors (e.g., the processing circuit 340) to perform at least one of the various operations described herein.

In some embodiments, the interface 345 may include at least one of network devices, input devices, output devices, and/or programmable devices. For example, the interface 345 may include one or more of transmitters, transceivers, receivers, antennas, network jacks, network interface cards, or other devices to facilitate communication (e.g., telecommunication, electronic communication, web-based communication, etc.) between one or more devices. As another example, the interface 345 may include a human-machine interface (HMI), a monitor, a display device, a dashboard device, a keyboard, a mouse, a dial pad, or other devices to receive and/or provide information. In some embodiments, the interface 345 may include wired and/or wireless connections. For example, the control system 335 may be wired (e.g., connected) to the inverter 145 via the interface 345. As another example, the interface 345 may facilitate wireless communication between a controller of the inverter 145 and the control system 335.

In some embodiments, the interface 345 may establish and/or provide one or more forms of communication. For example, the interface 345 may include a global system for mobile communications (GSM) modem to enable communication with one or more components of the power conversion system 100. As another example, the interface 345 may establish a controller area network (CAN) bus such that one or more components of the power conversion system 100 may communicate with one another. In some embodiments, the interface 345 may receive electrical energy from the power conversion system 100. For example, the solar cells 122 may provide electrical energy to the interface 345 to power one or more operations of the interface 345. As another example, the inverter 145 may provide electrical energy to the interface 345.

In some embodiments, the interface 345 may provide electrical coupling features such that one or more devices may electrically couple with one or more components of the power conversion system 100 via the interface 345. For example, the interface 345 may include electrical receptacles, electrical terminals, outlets, termination ports, or other circuitry components to electrical couple devices to one another. As a non-limiting example, the interface 345 may include a universal serial bus (USB) outlet to receive an electrical cable or electrical cord that includes a USB connector. As another non-limiting example, the interface 345 may include an AC outlet (e.g., 120 VAC, 240 VAC, etc.) to electrical couple a device, that receives AC power, with the inverter 145.

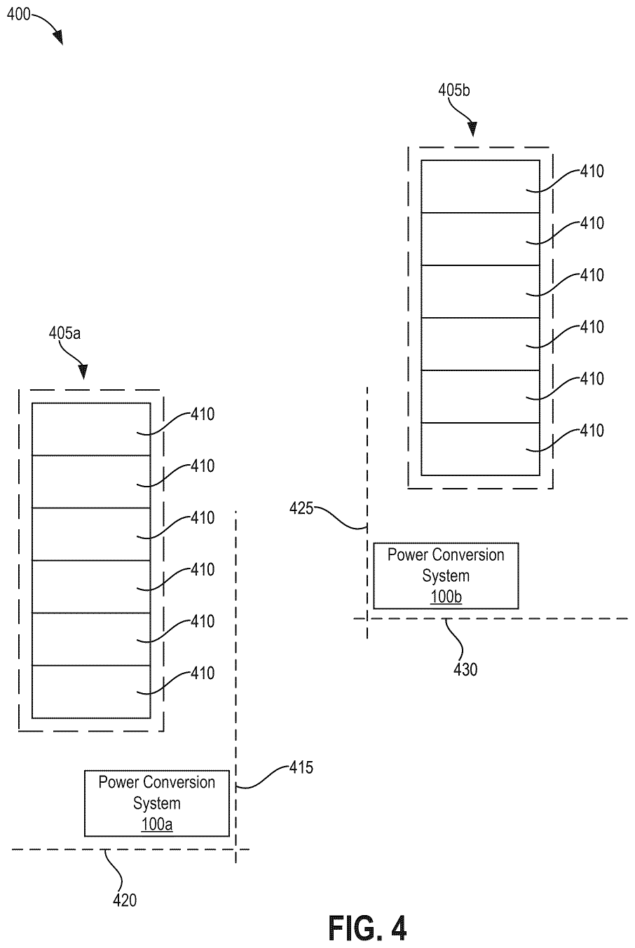

FIG. 4 depicts an aerial view of a renewable energy site 400, according to some embodiments. In some embodiments, the illustration of FIG. 4 provides an example of a completed site (e.g., the renewable energy site 400 is illustrated as being completed). As shown in FIG. 4, the renewable energy site 400 may include one or more photovoltaic (PV) power stations, shown as power stations 405a and 405b, and the power conversion system 100. The power stations 405a and 405b are shown to include one or more solar arrays 410.

In some embodiments, the processing circuit 340 may implement one or more location determination techniques. For example, the processing circuit 340 may implement cellular triangulation to determine a location of the power conversion system 100. As another example, the processing circuit 340 may receive, via the interface 345, global positioning system (GPS) location information. In some embodiments, the processing circuit 340 may provide and/or share the location information of the power conversion system 100. For example, the processing circuit 340 may provide the location information to the remote system 350.

In some embodiments, the processing circuit 340 may provide the location information of the power conversion system 100 to assist in identifying and/or locating the power conversion system 100. For example, the processing circuit 340 may provide the location information to service technician and/or other possible operator that is visiting the renewable energy site 400 to service the power conversion system 100. In some embodiments, the size (e.g., acreage, dimensions, square footage, etc.) of the renewable energy site 400 may complicate and/or interfere with locating equipment at the renewable energy site 400. For example, the renewable energy site 400 may be a 500 acre field. To continue this example, it would be time exhaustive for a service technician to navigate and/or search the entire renewable energy site to find one or more components.

To assist in the identification of the power conversion system 100, the processing circuit 340 may share location information and/or identifiable information of the power conversion system 100. For example, the processing circuit 340 may transmit one or more signals to a mobile device (e.g., the remote system 350) associated with the service technician. To continue this example, the processing circuit 340 may provide the location information via the one or more signals.

In some embodiments, the processing circuit 340 may share location information of the power conversion system 100 relative to the renewable energy site. For example, as shown in FIG. 4, the intersection point of line 415 and line 420 may represent a location of a power conversion system 100a relative to the renewable energy site 400. As another example, as shown in FIG. 4, the intersection point of line 425 and line 430 may represent a location of a power conversion system 100b relative to the renewable energy site 400.

In some embodiments, the aerial view of the renewable energy site 400, as shown in FIG. 4, may be presented and/or provided as one or more graphical representations. For example, the processing circuit 340 may provide location information to the remote system 350 to cause the remote system 350 to display one or more user interfaces to present a digital and/or virtual representation of the aerial view of the renewable energy site 400.

### Configuration of Exemplary Embodiments

In an illustrative embodiment, any of the operations described herein can be implemented at least in part as computer-readable instructions stored on a computer-readable memory. Upon execution of the computer-readable instructions by a processor, the computer-readable instructions can cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A power conversion system, comprising:
a housing comprising a plurality of sides, the plurality of sides to define a shape of the housing;
a frame disposable on a ground surface and the frame configured to support the housing;
a solar assembly coupled with a first side of the plurality of sides, the solar assembly comprising a plurality of solar cells;
an inverter electrically coupled with the solar assembly, the inverter configured to:
receive direct current (DC) power from the plurality of solar cells;
convert the DC power into alternating current (AC) power; and
provide the AC power to a temperature management system of the power conversion system; and
the temperature management system configured to:
monitor an environment of an internal cavity of the housing; and
provide temperature-controlled air throughout the internal cavity of the housing to control the environment of the internal cavity of the housing.

2. The power conversion system of claim 1, wherein the temperature management system includes a processing circuit, a heating, ventilation, and air conditioning (HVAC) system, and one or more sensors.

3. The power conversion system of claim 2, wherein the temperature management system receives power from the inverter.

4. The power conversion system of claim 2, wherein the HVAC system includes one or more of fans, cooling systems, heating elements, temperature control devices, vapor-compression devices, and air circulation devices.

5. The power conversion system of claim 2, wherein the HVAC system includes one or more of dehumidification systems and absorbent materials.

6. The power conversion system of claim 2, wherein the one or more sensors include temperature sensors and humidity sensors.

7. A power conversion system, comprising:
a housing comprising a cavity to dispose an inverter;
a solar assembly coupled with an external side of the housing, the solar assembly comprising a plurality of solar cells; and
an environment management system electrically coupled with the plurality of solar cells, the environment management system configured to:
receive direct current (DC) power from the plurality of solar cells; and
control an environment throughout the cavity.

8. The power conversion system of claim 7, further comprising an energy storage device configured to store DC power produced by the plurality of solar cells.

9. The power conversion system of claim 7, wherein the environment management system further comprises a ventilation assembly positioned within the housing to provide airflow throughout the cavity.

10. The power conversion system of claim 7, further comprising:
a control system configured to receive environmental data from sensors within the cavity and adjust environment management functions accordingly.

11. The power conversion system of claim 7, further comprising:
an energy storage device configured to store DC power generated by the plurality of solar cells.

12. A power conversion system, comprising:
a housing defining an internal cavity;
a solar assembly coupled to an external side of the housing, the solar assembly comprising a plurality of solar cells configured to generate direct current (DC) power; and
an inverter electrically coupled with the solar assembly and configured to:
receive DC power from the plurality of solar cells;
convert the DC power into alternating current (AC) power; and
provide the AC power to an environment management system within the housing;
wherein the environment management system is configured to:
monitor environmental conditions within the internal cavity; and
regulate temperature by circulating temperature-controlled air within the internal cavity using the AC power.

13. The power conversion system of claim 12, wherein the environment management system further comprises a ventilation assembly positioned within the housing to provide airflow throughout the internal cavity.

14. The power conversion system of claim 12, wherein the environment management system comprises a dehumidification unit to regulate moisture levels within the internal cavity.

15. The power conversion system of claim 12, wherein the solar assembly is positioned on a top surface of the housing to maximize solar exposure.

16. The power conversion system of claim 12, further comprising:
a control system configured to receive environmental data from sensors within the internal cavity and adjust environmental management functions accordingly.

17. The power conversion system of claim 12, further comprising:
an energy storage device configured to store DC power generated by the plurality of solar cells.

18. The power conversion system of claim 17, wherein the energy storage device is configured to discharge power to the inverter during periods when solar cells are inactive.

19. The power conversion system of claim 12, further comprising:
a frame positioned beneath the housing to support the housing on a ground surface.

20. The power conversion system of claim 12, wherein the inverter is configured to perform DC-to-DC power conversion, enabling variable voltage supply for multiple components within the environment management system.
